(19) United States
(12) Patent Application Publication
(10) Pub. No.: US 2015/0099600 A1
(43) Pub. Date: Apr. 9, 2015

(54) ELECTRICAL AXLE

(71) Applicant: BorgWarner Torq Transfer Systems AB, Landskrona (SE)

(72) Inventors: Kristoffer Nilsson, Lund (SE); Gustaf Lagunoff, Malmo (SE)

(21) Appl. No.: 14/396,770

(22) PCT Filed: Mar. 15, 2013
(86) PCT No.: PCT/EP2013/055380

§ 371 Date: Oct. 24, 2014

(30) Foreign Application Priority Data
Apr. 27, 2012 (SE) 1250424-7

(51) Int. Cl. B60K 17/12; B60K 17/16; B60K 11/02

(52) U.S. Cl. CPC B60K 17/12; B60K 11/02; B60K 17/165; Y10S 903/91
USPC 475/150; 180/65.21; 903/910

(57) ABSTRACT

An electrical axle for a four wheeled road vehicle is provided. The electrical axle comprises an electrical propulsion motor (110) arranged coaxially on said axle (100), a differential mechanism (120) being connected to said electrical propulsion motor for driving two wheels arranged on a first side (160) and a second side (162) of said electrical axle (100), and an electrical torque vectoring motor (132) arranged coaxially on said axle (100) and connected to said fist side (160) and second side (162) for providing a change in torque distribution between said first side (160) and said second side (162) of said axle (100), wherein the diameter of the torque vectoring motor (132) is less than the diameter of the electrical propulsion motor (110).

### TECHNICAL FIELD The present invention relates to an electrical axle of a four wheeled vehicle.

More particularly, the present invention relates to an electrical axle having a torque vectoring unit for providing a torque difference between a right wheel and a left wheel of said axle.

### BACKGROUND

There is an increasing demand of providing four wheeled vehicles, such as cars, with propulsion units being more environmentally friendly than traditional combustion engines. A particular choice for such propulsion unit includes the use of electrical motors.

An electrical propulsion motor is typically arranged on a driving axle of the vehicle and provides torque to the driving wheels via a differential. Although it is possible to replace a combustion engine with such electrical driving axle the main track for many car manufacturers is to provide the electrical axle as an addition to the main combustion engine. Hence, such hybrid cars will have the possibility to switch propulsion unit for reducing the impact of the environment, as well as to improve driving characteristics of the vehicle.

One example of an electrical axle is described in the co-pending application PCT/EP2011/070253 by the same applicant, where the electrical propulsion motor is arranged coaxially on the axle together with a torque vectoring unit. The torque vectoring unit includes an electrical motor coupled to a differential mechanism of the electrical axle such that, upon activation, it provides a positive torque to one wheel and an opposite torque to another wheel, each wheels being disposed on the same axle.

If such electrical axle is installed in a hybrid car, e.g. in a car having a combustion engine coupled to the front axle, it is desirable to arrange the electrical axle on the rear axle of the vehicle. However, since the available space at the rear axle often is extremely limited it is necessary to provide a very compact packing of the electrical axle. This is rendered even more difficult in hybrid applications where the exhaust system of the combustion engine must pass the electrical axle.

There is thus a need for an improved electrical axle allowing for a more compact packing without reducing the performance or functionality of the electrical axle.

### SUMMARY

Accordingly, the present invention preferably seeks to mitigate, alleviate or eliminate one or more of the above-identified deficiencies in the art and disadvantages singly or in any combination and solves at least the above-mentioned problems by providing a device according to the appended claims.

It is thus an object of the invention to provide an electrical axle with a torque vectoring unit, which overcomes the above mentioned problems.

An idea of the present invention is to provide an electrical axle which allows for an improved packing of reduced size.

A further idea of the present invention to allow a more compact packing of the electrical axle without reducing the size of the electrical propulsion motor.

According to a first aspect, an electrical axle for a four wheeled road vehicle is provided. The electrical axle comprises an electrical propulsion motor arranged coaxially on said axle, a differential mechanism being connected to said electrical propulsion motor for driving two wheels arranged on a first side and a second side of said electrical axle, and an electrical torque vectoring motor arranged coaxially on said axle and connected to said fist side and second side for providing a change in torque distribution between said first side and said second side of said axle, wherein the diameter of the torque vectoring motor is less than the diameter of the electrical propulsion motor.

The electrical torque vectoring motor may be arranged at a lateral end of said axle whereby an exhaust system, normally arranged at a lateral side of the vehicle, may pass the electrical axle without any further modifications.

The outer diameter of the electrical torque vectoring motor may be between 45 and 80% of the outer diameter of the electrical propulsion motor. Hence, improved packing may be achieved while still providing necessary performance of the electrical torque vectoring motor.

The electrical propulsion motor, the differential mechanism, and the electrical torque vectoring motor may be enclosed within a housing, and wherein said housing forms a passage for an exhaust system of a combustion engine. Due to the common housing improved packing is provided.

The maximum rotation speed of the electrical torque vectoring motor may be between 8000 and 25000 rpm. This enables high reduction of an reduction gear such that the torque level of the motor may be decreased.

The electrical torque vectoring motor may further comprise an oil cooling system for improving the cooling and thus allowing a reduced diameter.

A ratio between the inner diameter of the electrical torque vectoring motor rotor and the outer diameter of the electrical torque vectoring motor stator may be between 48/136 and 65/136, such that torque, provided by the electrical propulsion motor via the differential mechanism may pass through the center of the rotor to an adjacent wheel shaft.

The electrical torque vectoring motor may comprise at least one phase connector arranged radially. Since a rotor diameter decrease may be compensated by increasing the lateral length of the motor, such increase of length may be provided by arranging phase connectors radially instead of axially.

The electrical torque vectoring motor may comprise at least one temperature sensor arranged in the winding of said electrical torque vectoring motor, whereby it will be possible to drive the electrical torque vectoring motor further towards it maximum limit.

The differential mechanism may comprise a first planetary gear arranged on one side of the electrical propulsion motor and connected to said electrical propulsion motor and to a first side of said axle, and a second planetary gear arranged between the electrical propulsion motor and the electrical torque vectoring motor and connected to said electrical propulsion motor and to a second side of said axle. The electrical torque vectoring motor may further be connected to the second planetary gear directly, and to the first planetary gear via a balancing shaft extending parallel with the electrical axle. Such differential mechanism is advantageous in that it provides a significant decrease in torque bias ratio as compared to standard bevel differentials.

The electrical torque vectoring motor may be connected to the first and second planetary gears via a reduction gear, whereby the torque level provided by the electrical torque vectoring motor may be decreased.

The electrical torque vectoring motor may be a permanent magnet synchronous reluctance motor or a switched reluctance motor. This is advantageous in that the torque density of the electrical torque vectoring motor may be increased such that the diameter may be reduced.

The electrical torque vectoring motor may comprise end plates in order to provide improved balancing.

The electrical torque vectoring motor may be controlled by means of a controller configured to transmit control signals to said electrical torque vectoring motor for increasing the torque-current ratio of said electrical torque vectoring motor. Said controller may further be configured to utilize real time torque derating based on a thermal model as well as on temperature sensor signals. Additionally, said controller may be configured to control an adaptive cooling flow to said electrical torque vectoring motor based on a thermal model as well as on temperature sensor signals.

According to a second aspect, a four wheeled road vehicle is provided, comprising an electrical axle according to the first aspect.

### BRIEF DESCRIPTION OF DRAWINGS

Hereinafter, the invention will be described with reference to the appended drawings, wherein:

FIG. 1 is a cross sectional view of an electrical axle of a vehicle according to an embodiment; and

FIG. 2 is an isometric view of the electrical axle shown in FIG. 1.

### DETAILED DESCRIPTION

Several embodiments of the present invention will be described in more detail below with reference to the accompanying drawings in order for those skilled in the art to be able to carry out the invention. The invention may, however, be embodied in many different forms and should not be construed as limited to the embodiments set forth herein. Rather, these embodiments are provided so that this disclosure will be thorough and complete, and will fully convey the scope of the invention to those skilled in the art. The embodiments do not limit the invention, but the invention is only limited by the appended claims. Furthermore, the terminology used in the detailed description of the particular embodiments illustrated in the accompanying drawings is not intended to be limiting of the invention.

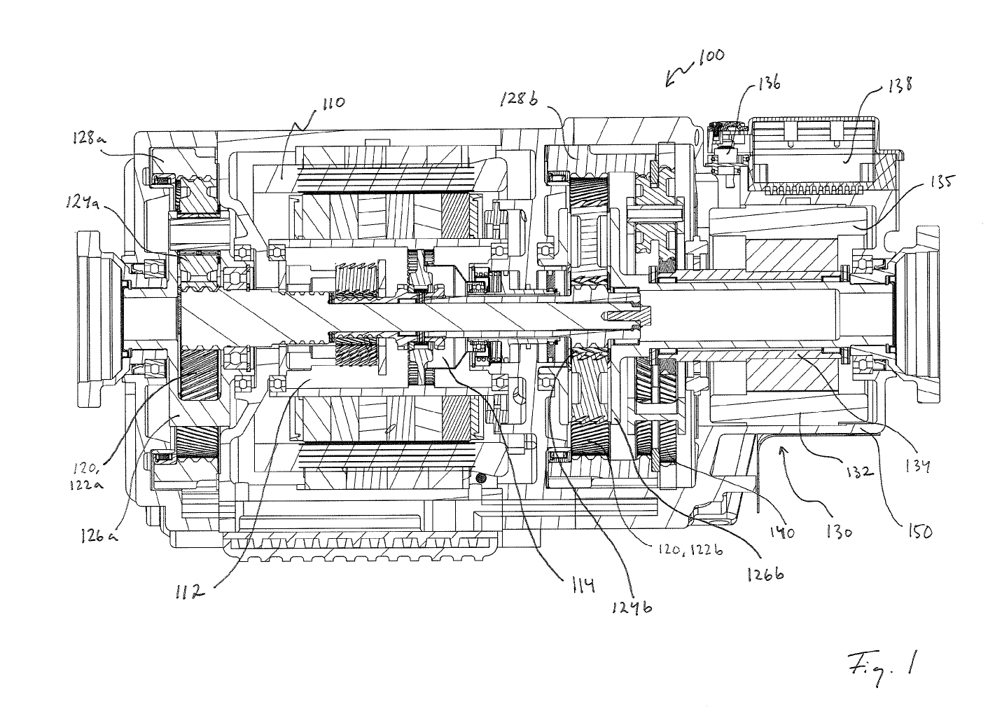

Starting with FIG. 1, an embodiment of an electrical axle 100 is shown. The electrical axle 100 may preferably be implemented as the rear axle in a four wheeled vehicle, such as a car, having a combustion engine driving the front axle. Hence, the electrical axle may be arranged for providing four wheel drive mode as well as for allowing changing the drive mode between front wheel drive and rear wheel drive. However, other drive line configurations are of course also possible and these are e.g. described in the co-pending application WO2010101506 by the same applicant.

The electrical axle 100 includes an electrical propulsion motor 110 arranged coaxially on the axle 100 such that the rotor 112 of the electrical propulsion motor 110 is aligned with the longitudinal axis of the axle 100. The rotor 112 may in some embodiments include a gear box 114, which will not be described further here.

The electrical propulsion motor 110 is connected on each lateral side to a differential mechanism 120 consisting of two coaxially aligned planetary gears 122a, 122b, of which the electrical propulsion motor 110 is driving the sun gears 124a, 124b. The left and right wheel shafts are connected to the planetary carriers 126a, 126b of the respective planetary gears 122a, 122b. The ring gear 128a, 128b of the respective planetary gear 122a, 122b has an outer surface which is connectable, e.g. by means of teeth, to a torque vectoring device 130.

The torque vectoring device 130 includes an electrical torque vectoring motor 132 arranged coaxially on the axle 100, such that the rotational axis of the rotor 134 of the electrical torque vectoring motor 132 is aligned with the rotational axis of the electrical propulsion motor 110. The electrical torque vectoring motor 132 is further arranged distally of the differential mechanism 120, i.e. between one of the planetary gears 120a, 120b and the adjacent wheel shaft. As can be seen in FIG. 1, the diameter of the electrical torque vectoring motor 132 is substantially smaller than the diameter of the electrical propulsion motor 110.

The electrical torque vectoring motor 132 is connected to the ring wheels 128a, 128b via a reduction gear 140. The gear reduction 140 is driven by the electrical torque vectoring motor 132 and may be a cycloidal drive, a double cycloidal drive, or a differential planetary gear as is described in PCT/EP2011/070253.

The output of the reduction gear 140 is preferably directly connected to the ring wheel 128b of the second planetary gear 122b, and connected to the ring wheel 128a of the first planetary gear 122a via a rotatable balancing shaft (not shown) extending parallel with the axle 100, and provided with gears for engagement with the ring gear 128a of the planetary gear 122a. The gears of the balancing shaft are configured for transmitting torque to the planetary gear 122a upon rotation of the balancing shaft, wherein the torque transmitted to the planetary gear 122a has an opposite direction compared to the torque transmitted to the other planetary gear 122b directly.

Now turning to the details of the electrical torque vectoring motor 132, a number of embodiments are possible for increasing the performance of the motor 132. The reduced diameter of the electrical torque vectoring motor 132 will lead to a significant reduction of performance. However, this may be compensated by improving some features of the electrical torque vectoring motor 132.

In one embodiment, the reduction of the reduction gear 140 is sufficiently high in order to decrease the torque level of the motor 132. By decreasing the torque level the diameter of the motor 132 may be made even smaller, and the reduction gear 140 may for this purpose provide a reduction between 30:1 and 40:1, preferably 34:1.

Despite the high reduction, the reduction gear 140 may have a high efficiency such that the torque is not being lost as friction. Hence, the torque may be reduced and the diameter of the electrical torque vectoring motor 132 may be correspondingly decreased. For this purpose the reduction gear 140 should be selected from high efficiency reduction gears, and it should further be optimized with regards to the efficiency required.

In a further embodiment it may be desired to reduce the torque bias ratio of the differential mechanism 120, such that the torque provided by the electrical torque vectoring motor 132 is transmitted to the differential mechanism 120 with a minimum of friction losses. This may e.g. be achieved by providing the differential mechanism 120 as the double planetary gears 122a, 122b, which construction has a significantly reduced torque bias ratio than conventional bevel differentials. Further to this, the torque bias ratio may be further decreased by optimizing the angles of the helical teeth of the differential mechanism whereby reaction forces causing friction are minimized. Moreover, it is preferred to improve the bearings of the ring wheels 128a, 128b for minimizing friction torque. This may e.g. be achieved by selecting a low friction material for the axial slide washers of the planetary differential 120. Typically, by providing the differential mechanism 120 by means of the double planetary gears 122a, 122b the torque bias ratio is below 1,1. This value is well below the typical value for a conventional differential having conical teeth, of which the torque bias ratio lies in the range of 1,2 to 1,5. Hence, the torque may be reduced and the diameter of the electrical torque vectoring motor 132 may be further decreased.

Preferably, the torque density of the electrical torque vectoring motor 132 is increased, whereby the diameter of the motor 132 may be made even smaller. This may e.g. be achieved by providing electrical torque vectoring motor 132 as a PMSRM motor having a high ratio of reluctance torque, iron and magnets of high quality, and an increased concentration of windings for enabling an increased length for the active part of the motor. However, it may also be possible to increase the torque density by selecting a switched reluctance motor having an increased concentration of windings as well as a comparably low base speed, whereby a less current and thus decreased copper losses allows smaller motor size requirements with regards to cooling needs. In a preferred embodiment the electrical torque vectoring motor 132 is configured to operate at high speed, such as 20000 rpm. This enables the high reduction of the reduction gear 140, such that the torque level of the motor 132 may be decreased. The electrical motor 132 may for this purpose be provided as a switched reluctance motor, or a PMSM motor.

Conventionally, electrical motors suitable for being implemented as the electrical torque vectoring motor 132 are provided with a water mantle for cooling the rotating parts of the motor. However, the outer diameter of such torque vectoring motor 132 may be further decreased if a more efficient cooling is provided. For this purpose the electrical torque vectoring motor 132 may instead have an oil cooling system.

Another advantageous feature for reducing the size of the electrical torque vectoring motor 132 is to arrange it immediately in a housing 150 of the electrical axle 100 without any intermediate parts.

In a yet further embodiment, the diameter of the rotor 134 of the electrical torque vectoring motor 132 is relatively large compared to the outer diameter of the stator 135 such that torque, provided by the electrical propulsion motor 110 via the differential mechanism 120 may pass through the center of the rotor 134 to the wheel shaft (not shown). The ratio between the diameter of the rotor 134 and the diameter of the stator 135 may preferably be between 50/136 and 60/136, to be compared with the corresponding ratio for a prior art electrical torque vectoring motor typically lying in the range of 40/136 or less.

Further, the torque characteristics of the electrical torque vectoring motor 132 may be designed such that it provides high torque only for the low speed required for torque vectoring. This may be achieved by choosing a switched reluctance motor having an extremely high field weakening ratio, or selecting a PMSRM motor having as high field weakening ratio as possible preferably with the option to implement active short circuiting at extremely high speeds for protecting the motor from overvoltage.

A decrease of the diameter of the rotor 134 may further be compensated by increasing the lateral length of the motor 132. In order to allow such increase of length, the electrical torque vectoring motor 132 may be provided with phase connectors 136 arranged radially instead of axially. The phase connectors 136 may be connected to power electronics arranged within a housing 138 arranged radially outside of the housing 150.

It is further advantageous to provide an increased balancing of the electrical torque vectoring motor 132 for reducing vibrations. This is particularly desired for the preferred motor 132 operating at the high speed, e.g. at 20.000 rpm. Increased balancing may e.g. by achieved by providing the electrical torque vectoring motor 132 with end plates.

Another important parameter is the temperature of the electrical torque vectoring motor 132. By reducing the heat dissipation within the motor the size may be reduced. This may be accomplished by providing an improved control algorithm, wherein the activation and operation of the electrical torque vectoring motor 132 is optimized with respect to the driving characteristics of the vehicle. For this purpose a feedback control of the torque may be implemented whereby only the required torque is provided. Another preferred option is to provide a control algorithm for the electrical torque vectoring motor 132 such that the operation is optimized for a high torque-current ratio. A yet further embodiment utilizes real time torque derating, which is based on a thermal model and signals from included temperature sensors. Such control algorithm thus enables full utilization of the capacity of the motor without the need for temperature margins. A thermal model, using input from the temperature sensors of the motor 132, may also be provided for allowing adaptive cooling flow to the motor.

In addition to this it may be advantageous to provide temperature sensors (not shown), either one or a plurality of such, inside the winding of the torque vectoring motor 132. Such provision will make it possible to drive the motor 132 further towards it maximum limit. Such optimization of operating the motor 132 will also make it possible to further reduce the size, in particular the outer diameter, of the motor 132.

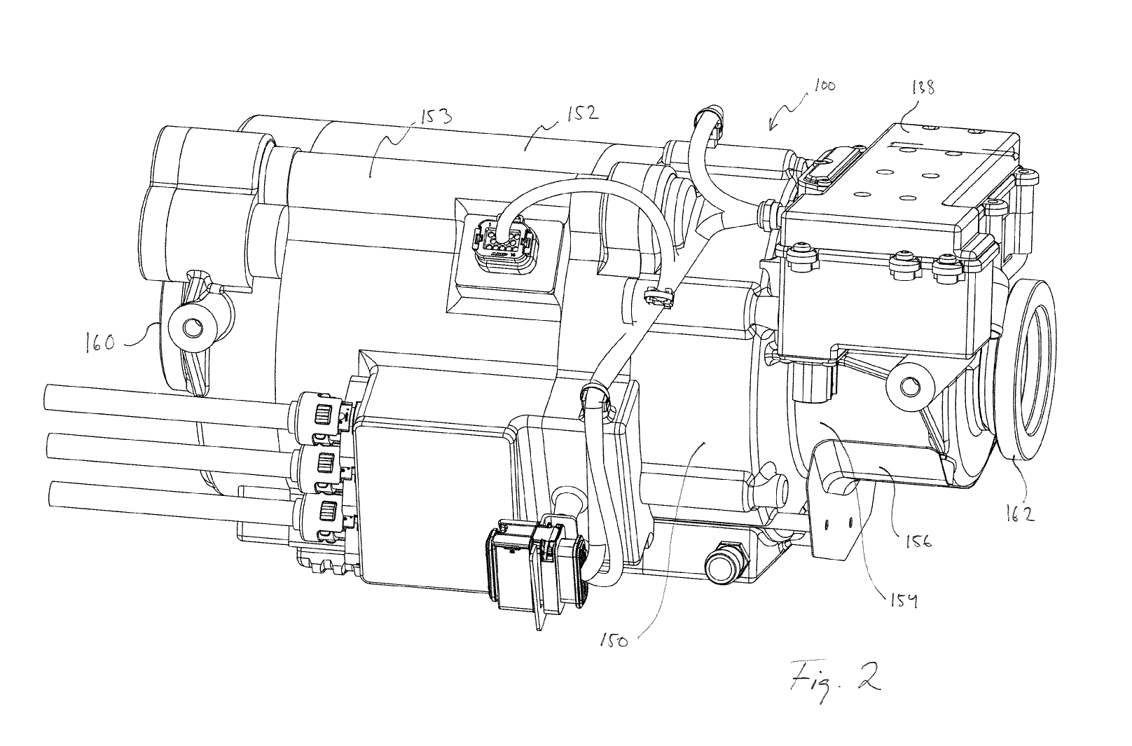

Now turning to FIG. 2 a perspective view of the electrical axle 100 shown in FIG. 1 is illustrated. The propulsion motor 110, the differential mechanism 120, the torque vectoring unit 130 (including the reduction gear 140) are enclosed within the housing 150 which forms two compartments 152, 154. The first compartment 152 extends laterally from a first side 160 of the electrical axle 100 towards the opposite side 162 of the axle 100 and encloses the electrical propulsion motor 110 and the differential mechanism 120. Further, the first compartment 152 includes a protrusion 153 enclosing the balance shaft connecting the torque vectoring unit 130 to the differential mechanism 120.

The second compartment 154 extends laterally from the end of the first compartment 152 to the second side 162 of the axle. The second compartment 154 thus encloses the torque vectoring motor 132, why the radial size of the second compartment 154 maybe much smaller than the radial size of the first compartment 152. Further to this, a cover plate, or heat shield, 156 is attached to the second compartment 154 for protecting the second compartment 154 from excess heat dissipated from the exhaust system if such system is arranged to pass the electrical axle 100.

In order to provide an improved packing the dimensions of the motors 110, 132 should be carefully determined. It has been found that the outer diameter of the propulsion motor 110 should be between 200 and 240 mm, preferably around 220 mm.

In comparison to this the outer diameter of the electrical torque vectoring motor 132 should be between 100 and 150 mm, and preferably around 135 mm.

It will be appreciated that the embodiments described in the foregoing may be combined without departing from the scope as defined by the appended patent claims. Although the present invention has been described above with reference to specific embodiments, it is not intended to be limited to the specific form set forth herein. Rather, the invention is limited only by the accompanying claims and, other embodiments than the specific above are equally possible within the scope of these appended claims.

In the claims, the term “comprises/comprising” does not exclude the presence of other elements or steps. Furthermore, although individually listed, a plurality of means, elements or method steps may be implemented by e.g. a single unit or processor. Additionally, although individual features may be included in different claims, these may possibly advantageously be combined, and the inclusion in different claims does not imply that a combination of features is not feasible and/or advantageous. In addition, singular references do not exclude a plurality. The terms “a”, “an”, “first”, “second” etc do not preclude a plurality. Reference signs in the claims are provided merely as a clarifying example and shall not be construed as limiting the scope of the claims in any way.

1. An electrical axle for a four wheeled road vehicle, comprising
an electrical propulsion motor arranged coaxially on said axle,
a differential mechanism being connected to said electrical propulsion motor for driving two wheels arranged on a first side and a second side of said electrical axle, and
an electrical torque vectoring motor arranged coaxially on said axle and connected to said first side and second side for providing a change in torque distribution between said first side and said second side of said axle,
wherein the diameter of the torque vectoring motor is less than the diameter of the electrical propulsion motor.

2. The electrical axle according to claim 1, wherein the electrical torque vectoring motor is arranged at a lateral end of said axle.

3. The electrical axle according to claim 1, wherein the outer diameter of the electrical torque vectoring motor is between 45 and 80% of the outer diameter of the electrical propulsion motor.

4. The electrical axle according to claim 1, wherein the electrical propulsion motor, the differential mechanism, and the electrical torque vectoring motor are enclosed within a housing, and wherein said housing forms a passage for an exhaust system of a combustion engine.

5. The electrical axle according to claim 1, wherein the maximum rotation speed of the electrical torque vectoring motor is between 8000 and 25000 rpm.

6. The electrical axle according to claim 1, wherein the electrical torque vectoring motor further comprises an oil cooling system.

7. The electrical axle according to claim 1, wherein a ratio between the inner diameter of the electrical torque vectoring motor rotor and the outer diameter of the electrical torque vectoring motor stator is between 48/136 and 65/136.

8. The electrical axle according to claim 1, wherein the electrical torque vectoring motor comprises at least one phase connector arranged radially.

9. The electrical axle according to claim 1, wherein the electrical torque vectoring motor comprises at least one temperature sensor arranged in the winding of said electrical torque vectoring motor.

10. The electrical axle according to claim 1, wherein the differential mechanism comprises a first planetary gear arranged on one side of the electrical propulsion motor and connected to said electrical propulsion motor and to a first side of said axle, and a second planetary gear arranged between the electrical propulsion motor and the electrical torque vectoring motor and connected to said electrical propulsion motor and to a second side of said axle.

11. The electrical axle according to claim 10, wherein the electrical torque vectoring motor is connected to the second planetary gear directly, and to the first planetary gear via a balancing shaft extending parallel with the electrical axle.

12. The electrical axle according to claim 11, wherein the electrical torque vectoring motor is connected to the first and second planetary gears via a reduction gear.

13. The electrical axle according to claim 1, wherein the electrical torque vectoring motor is a permanent magnet synchronous reluctance motor or a switched reluctance motor.

14. The electrical axle according to any one of the claim 1, wherein the electrical torque vectoring motor comprises end plates.

15. The electrical axle according to claim 1, wherein the electrical torque vectoring motor is controlled by means of a controller configured to transmit control signals to said electrical torque vectoring motor for increasing the torque-current ratio of said electrical torque vectoring motor.

16. The electrical axle according to claim 15, wherein said controller is configured to utilize real time torque derating based on a thermal model as well as on temperature sensor signals.

17. The electrical axle according to claim 16, wherein said controller is configured to control an adaptive cooling flow to said electrical torque vectoring motor based on a thermal model as well as on temperature sensor signals.

18. The electrical axle according to claim 11, wherein the torque bias of the differential mechanism is below 1,1.

19. A four wheeled road vehicle, comprising an electrical axle according to claim 1.

20. The electrical axle according to claim 15, wherein said controller is configured to control an adaptive cooling flow to said electrical torque vectoring motor based on a thermal model as well as on temperature sensor signals.

21. The electrical axle according to claim 10, wherein the torque bias of the differential mechanism is below 1,1.
